(19) United States
(12) Patent Application Publication
(10) Pub. No.: US 2024/0028852 A1
(43) Pub. Date: Jan. 25, 2024

(54) QR Code Memorial Device

(71) Applicant: Jonathan Blackshear, Dublin, GA (US)

(72) Inventor: Jonathan Blackshear, Dublin, GA (US)

(21) Appl. No.: 18/355,112

(22) Filed: Jul. 19, 2023

Related U.S. Application Data
(60) Provisional application No. 63/390,496, filed on Jul. 19, 2022.

(51) Int. Cl. G06K 7/14; G06K 19/06

(52) U.S. Cl. CPC G06K 7/1417; G06K 19/06037

(57) ABSTRACT

A QR code memorial device is disclosed, which comprises a website or mobile application that allows a user to order decorative bar/QR codes that can be affixed to a gravestone. When the QR code is scanned, the code may display a photograph, video, or favorite music of the deceased person. Further, different subscription levels of the application may allow for various media displaying functions and content storage, as well as different account plans for single users, families, etc. Additionally, there may be several categories for information displayed on each profile, such as videos, photos, favorite music, etc. Thus, the QR code helps memorialize deceased individuals in a digital manner.

### CROSS-REFERENCE TO RELATED APPLICATION

The present application claims priority to, and the benefit of, U.S. Provisional Application No. 63/390,496, which was filed on Jul. 19, 2022, and is incorporated herein by reference in its entirety.

### FIELD OF THE INVENTION

The present invention relates generally to the field of QR code memorial devices. More specifically, the present invention relates to a memorial or gravesite with a scannable QR code capable of instantly displaying a profile of an individual buried at the site via a smartphone application. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in QR code memorial devices. Generally, as family and friends pass away and are buried in cemeteries, gravestones can wear away over time. Future generations may be unable to properly read engravings on the stones, and people will ultimately be forgotten. Without a way to identify who is buried under the gravestone, families may be disappointed at being unable to track their ancestry. Being able to see or hear what the deceased individual looked and sounded like may provide comfort for grieving friends and family.

Further, the use of gravestone markers to honor the memory of persons who have passed away, especially family members, is well known in the prior art. However, it would be desirable to include memorabilia in addition to the tombstone to honor the loved one that has passed away. For example, it would be desirable to provide photographs, videos, and music for display at the gravesite. However, most picture frames are designed to display indoors and are not weatherproof. Accordingly, pictures and other memorabilia in conventional picture frames at gravesites eventually become ruined by exposure to weather.

Accordingly, there is a demand for an improved QR code memorial device that provides a scannable QR code capable of displaying a profile of a deceased individual, such as photos, videos, music, etc. More particularly, there is a demand for a completely weatherproof QR code that does not wear away over time and allows users to see and hear what the deceased individual looked and sounded like.

Therefore, there exists a long-felt need in the art for a QR code memorial device that provides memorials and gravesites with a scannable QR code capable of instantly displaying the profile of an individual buried at the site via a smartphone application. There is also a long-felt need in the art for a QR code memorial device that displays a biography, obituary, family tree, photos, videos, and more once the QR code is scanned. Further, there is a long-felt need in the art for a QR code memorial device that allows deceased individuals to be remembered as they were, in good health and happy times. Moreover, there is a long-felt need in the art for a device that memorializes an individual for a long period of time, ensuring visitors can learn about people buried in specific areas. Further, there is a long-felt need in the art for a QR code memorial device that includes different subscription levels that can offer additional functions like content storage for single users, families, etc. Finally, there is a long-felt need in the art for a QR code memorial device that can be used for pets as well.

The subject matter disclosed and claimed herein, in one embodiment thereof, comprises a QR code memorial device. The device is a comprehensive memorial system for deceased individuals. The device comprises a website or mobile application that allows a user to order decorative bar/QR codes that can be affixed to a gravestone. When the QR code is scanned, the code may display a photograph, video, or favorite music of the deceased person. Further, different subscription levels of the application may allow for various media displaying functions and content storage, as well as different account plans for single users, families, etc. Additionally, there may be several categories for information displayed on each profile, such as videos, photos, favorite music, etc. Thus, the QR code helps memorialize deceased individuals in a digital manner. The device can be used for pets, as well.

In this manner, the QR code memorial device of the present invention accomplishes all of the foregoing objectives and provides users with a weatherproof device for storage of photos, videos, and music at a gravesite. The device is a QR code that can be scanned to instantly display a profile of a deceased individual. The device includes different subscription levels.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a QR code memorial device. The device is a comprehensive memorial system for deceased individuals. The device comprises a website or mobile application that allows a user to order decorative bar/QR codes that can be affixed to a gravestone. When the QR code is scanned, the code may display a photograph, video, or favorite music of the deceased person. Thus, the QR code helps memorialize deceased individuals in a digital manner. The device can be used for pets, as well.

In one embodiment, the QR code memorial device relates to a tombstone erected in a cemetery and equipped with a QR code, so as to be able to access a website that can commemorate the deceased. When a person dies at the end of his or her lifespan due to illness or old age, the body is buried in the ground, cremated, or buried in an ossuary. Generally, a headstone or plaque is used to identify the deceased. Further, on the surface of the headstone, simple family relationships such as the deceased's name, date of birth, date of death, and the names of the remaining family members of the deceased can be engraved. However, there is a regret that detailed information and photos about the deceased cannot be expressed on the stone, due to its small size. By attaching a QR (Quick Response) code to a part of the surface of the headstone or other object, it is possible to overcome the limitation of the size of the tombstone and provide various information about the deceased during his/her lifetime at the cemetery site, so that anyone visiting the cemetery can photograph the QR code using a smartphone.

The QR code is a two-dimensional code composed of various square patterns that is obtained by improving the long bar-shaped barcode commonly found on product packaging. The QR code allows a variety of information to be stored in both the horizontal and vertical directions, so it is possible to store a lot of information on a QR code. The number that can be stored in the QR code can be up to 7089 characters.

In one embodiment, the QR codes are located in a suitable predetermined position on the front or side of the main body of the tombstone, for example, conspicuously or in a natural standing position of a person. The QR codes can be printed directly on the surface of the main body or engraved, or the QR code is printed on the surface of a thin plastic film, and the back side of the plastic film is attached to the tombstone using an adhesive or double-sided adhesive tape. When formed by direct engraving, the contrast between the surface and the embossed part is very large, so that the surface is black to increase the recognition of the QR code, but the engraved part is white.

In one embodiment, a waterproofing coating or weatherproof coating is applied over the scannable QR code. Generally, the waterproof/weatherproof coating is a transparent resin which covers the entire QR code with a film and forms a tight seal. Thus, the QR code is protected and less affected by wind and rain, so that it can have a long service life. Further, the QR code within the seal remains dry even if the tombstone/headstone is exposed to extreme weather conditions, such as torrential rains, blizzards, or extremely hot and/or humid conditions, etc.

In one embodiment, the tombstone of the present invention includes a main body made of stone, wherein a scannable QR code is secured. A portable smartphone scans the QR code which engages a website through a wireless communication network. The website has a database for storing photos, videos, music, and histories of various activities of the deceased during his/her lifetime. Specifically, vivid life information of the deceased can be stored, for example, various photos and video information, various histories, family trees, records, chronicles, etc., and articles introducing and commemorating the deceased that the deceased's family will remember. Further, the information can be accessed by accessing the computer database that stores various information about the deceased at the cemetery site. The website is created by collecting related articles into a database, or other data collection area, etc.

Accordingly, the present invention does not have to engrave the detailed history of the deceased directly on the tombstone, thereby reducing the size of the tombstone and greatly reducing the cost of carving the tombstone. Further, anyone can check the life of the deceased at any time, so descendants and relatives, who have not seen the deceased can feel closer to the deceased and can cherish and commemorate the deceased for a long time.

In one embodiment, the device comprises different subscription levels of the application to allow for various media displaying functions and content storage. Users can pay more for a higher subscription level, which provides for displaying audio as well as photos. For example, the basic subscription level only provides for displaying photos of the deceased. The next subscription level provides for displaying photos and articles. Another subscription would provide for displaying photos, articles, and videos, family trees, etc. Further, the device can also include different account plans, such that single users can have less expensive plans than families of multiple users, etc. Additionally, there may be several categories to determine which type of information is to be displayed on each profile, such as videos, photos, favorite music, etc. Users would upload specific information in the correct category.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, smart devices, PDAs, tablets, pagers, routers, switches, etc.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

In one embodiment, a headstone/gravestone contains a two-dimensional barcode (or QR code). Other types of scannable codes could also be used in the same manner as the QR code. The QR code is uniquely associated with the deceased. In this manner, by scanning the QR code, an application executed on a smartphone can retrieve photos, videos, music, and other information about the deceased.

Furthermore, a database of QR codes can be maintained (i.e., on a server system with which a smartphone can communicate). Each of the QR codes in the database can be associated with a unique individual. The database can also store photos, videos, music, and other personal information for each of the individuals. In such cases, when a user scans a QR code with a smartphone, an application on the smartphone can access the database to identify the information associated with the specific QR code. Additionally, each QR code represents a unique identifier. When the QR code is scanned, the unique identifier for the QR code can be determined and used to query a data structure to obtain the personal information associated with the QR code.

In some embodiments, the present invention can provide a website or other application where an individual or other user can input their personal information or a deceased individual's personal information to receive a QR code associated with the personal information that can be displayed on a headstone/gravestone.

In one embodiment, an example computer environment includes a mobile computing device which may typically be a smartphone having a camera with which a QR code can be scanned. The mobile computing device is interconnected via a network with multiple server systems. The server systems can represent the systems where a user's or a deceased's personal information is stored. The specific manner in which the personal information is accessed is not essential to the invention. The network typically will be the internet although other networks can also be employed. For example, in a typical implementation, the mobile computing device will communicate with one or more of the server systems using a Wi-Fi or cellular (i.e., 4G) connection. Also, although this specification will primarily refer to using a smartphone, any mobile computing device capable of performing the described functionality could also be used (i.e., a tablet).

In one embodiment, the QR code memorial device can be utilized with any suitable gravestone, headstone, tombstone, memorial, etc., as is known in the art, including headstones, tombstones, and memorials for pets.

In yet another embodiment, the QR code memorial device comprises a plurality of indicia.

In yet another embodiment, a method of memorializing a deceased individual via a scannable QR code which displays photos, videos, and music relating to the deceased individual is disclosed. The method includes the steps of providing a QR code memorial device that provides a scannable QR code attributed to a deceased individual. The method also comprises attributing photos, videos, and music related to the deceased to the profile on the QR code memorial device. Further, the method comprises securing the QR code memorial device to a tombstone. Finally, the method comprises scanning the QR code to view photos, videos, and hear music related to the deceased on a smartphone.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the QR code memorial device of the present invention showing the device applied to a tombstone in accordance with the disclosed architecture;

FIG. 2 illustrates a front perspective view of one embodiment of the QR code memorial device of the present invention showing the weatherproof covering of the QR code in accordance with the disclosed architecture;

FIGS. 3A-B illustrate a perspective view of one embodiment of the QR code memorial device of the present invention showing how the smartphone application is accessed in accordance with the disclosed architecture;

FIGS. 4A-B illustrate a perspective view of one embodiment of the QR code memorial device of the present invention showing how the program is available on a smartphone or as a website in accordance with the disclosed architecture;

FIG. 5 illustrates a front perspective view of one embodiment of the QR code memorial device of the present invention in use in accordance with the disclosed architecture; and

FIG. 6 illustrates a flowchart showing the method of memorializing a deceased individual via a scannable QR code which displays photos, videos, and music relating to the deceased individual in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a QR code memorial device that provides memorials and gravesites with a scannable QR code capable of instantly displaying a profile of an individual buried at the site via a smartphone application. There is also a long-felt need in the art for a QR code memorial device that displays a biography, obituary, family tree, photos, videos, and more once the QR code is scanned. Further, there is a long-felt need in the art for a QR code memorial device that allows deceased individuals to be remembered as they were, in good health and happy times. Moreover, there is a long-felt need in the art for a device that memorializes an individual for a long period of time, ensuring visitors can learn about people buried in specific areas. Further, there is a long-felt need in the art for a QR code memorial device that includes different subscription levels that can offer additional functions like content storage for single users, families, etc. Finally, there is a long-felt need in the art for a QR code memorial device that can be used for pets as well.

The present invention, in one exemplary embodiment, is a novel QR code memorial device. The device is a comprehensive memorial system for deceased individuals. The device comprises a website or mobile application that allows a user to order decorative bar/QR codes that can be affixed to a gravestone. When the QR code is scanned, the code may display a photograph, video, or favorite music of the deceased person. Further, different subscription levels of the application may allow for various media displaying functions and content storage, as well as different account plans for single users, families, etc. Additionally, there may be several categories for information displayed on each profile, such as videos, photos, favorite music, etc. Thus, the QR code helps memorialize deceased individuals in a digital manner. The present invention also includes a novel method of memorializing a deceased individual via a scannable QR code which displays photos, videos, and music relating to the deceased individual. The method includes the steps of providing a QR code memorial device that provides a scannable QR code attributed to a deceased individual. The method also comprises attributing photos, videos, and music related to the deceased to the profile on the QR code memorial device. Further, the method comprises securing the QR code memorial device to a tombstone. Finally, the method comprises scanning the QR code to view photos, videos, and hear music related to the deceased on a smartphone.

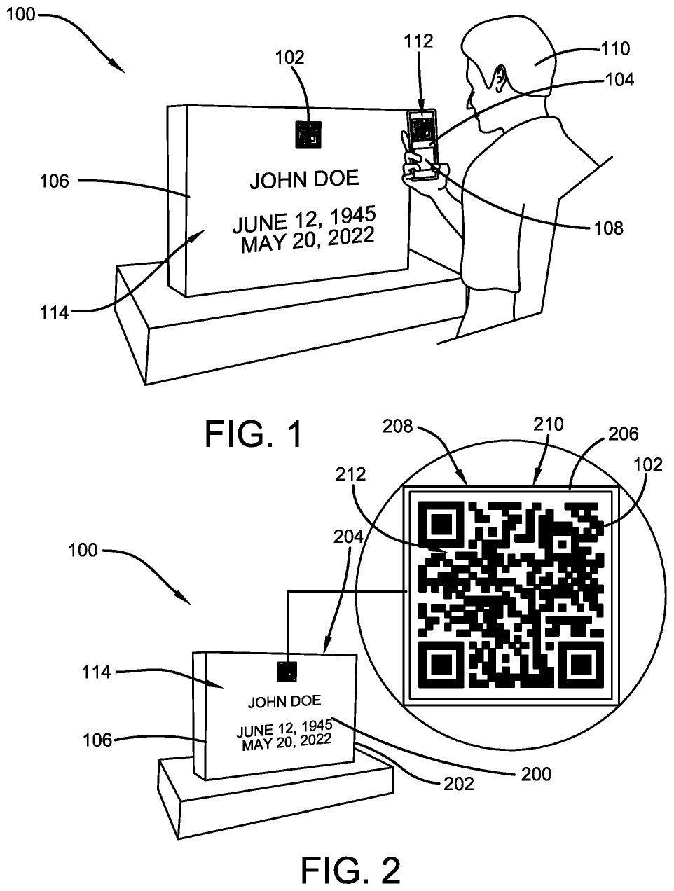

Referring initially to the drawings, FIG. 1 illustrates a perspective view of one embodiment of the QR code memorial device 100 of the present invention. In the present embodiment, the QR code memorial device 100 is an improved QR code memorial device 100 that provides a user 110 with a scannable QR code 102 capable of instantly displaying a profile of a deceased individual via a smartphone 104. Specifically, the device 100 includes a website or mobile application 108 that allows a user 110 to order decorative bar/QR codes 102 that can be affixed to a gravestone/tombstone 106. When the QR code 102 is scanned, the code 102 may display personal information 112, (i.e., photograph, video, or favorite music, etc.) of the deceased person. Thus, the QR code 102 helps memorialize deceased individuals in a digital manner.

Generally, the QR code memorial device 100 relates to a tombstone 106 erected in a cemetery and equipped with a scannable QR code 102, so as to be able to access a website 216 that can commemorate the deceased. When a person dies at the end of his or her lifespan due to illness or old age, the body is buried in the ground, cremated, or buried in an ossuary. Generally, a headstone 106 or plaque is used to identify the deceased. Further, on the surface 114 of the headstone 106, simple family relationships such as the deceased's name, date of birth, date of death, and the names of the remaining family members of the deceased can be engraved. However, there is a regret that detailed information and photos of the deceased cannot be expressed on the stone 106 due to its small size. By attaching a QR (Quick Response) code 102 to a part of the surface 114 of the headstone 106 or other object, it is possible to overcome the limitation of the size of the tombstone 106 and provide various information about the deceased during his/her lifetime at the cemetery site so that anyone visiting the cemetery can photograph the QR code 102 using a smartphone 104.

As shown in FIG. 2, the QR code 102 is a two-dimensional code composed of various square patterns that is obtained by improving the long bar-shaped barcode commonly found on product packaging. The QR code 102 allows a variety of information to be stored in both the horizontal and vertical directions, so it is possible to store a large amount of information on a QR code 102. Generally, the number that can be stored in the QR code 102 can be up to 7,089 characters.

Generally, the QR codes 102 are located in a suitable predetermined position on the front 200 or side 202 of the main body 204 of the tombstone 106, for example, conspicuously or in a natural standing position of a person. The QR codes 102 can be printed directly on the surface 114 of the main body 204 or engraved, or the QR code 102 is printed on the surface of a thin plastic film 206, and the back side 208 of the plastic film 206 is attached to the tombstone 106 using an adhesive 210 or double-sided adhesive tape. When formed by direct engraving, the contrast between the surface 114 and the embossed part is very large, so that the surface 114 is black to increase the recognition of the QR code 102, but the engraved part is white.

Further, a waterproofing coating 212 or weatherproof coating is applied over the scannable QR code 102. Generally, the waterproof/weatherproof coating 212 is a transparent resin which covers the entire QR code 102 with a film and forms a tight seal. Thus, the QR code 102 is protected and less affected by wind and rain so that it can have a long service life. Further, the QR code 102 within the seal (i.e., coating 212) remains dry even if the tombstone/headstone 106 is exposed to extreme weather conditions, such as torrential rains, blizzards, or extremely hot and/or humid conditions, etc.

Generally, the tombstone 106 of the present invention includes a main body 204 made of stone, wherein a scannable QR code 102 is secured. A portable smartphone 104 scans the QR code 102 which engages a website 216 through a wireless communication network 214. The website 216 has a database for storing personal information 212, such as photos, videos, music, and histories of various activities of the deceased during his/her lifetime. Specifically, vivid life information of the deceased can be stored, for example, various photos and video information, various histories, family trees, records, chronicles, etc., and articles introducing and commemorating the deceased that the deceased's family will remember. Further, the information 212 can be accessed by accessing the computer database 218 that stores various information about the deceased at the cemetery site. The website 216 is created by collecting related articles into a database 218, or other data collection areas, etc.

Accordingly, the present invention does not have to engrave the detailed history of the deceased directly on the tombstone 106, thereby reducing the size of the tombstone 106 and greatly reducing the cost of carving the tombstone 106. Further, anyone can check the life of the deceased at any time, so descendants and relatives, who have not seen the deceased can feel closer to the deceased and can cherish and commemorate the deceased for a long time.

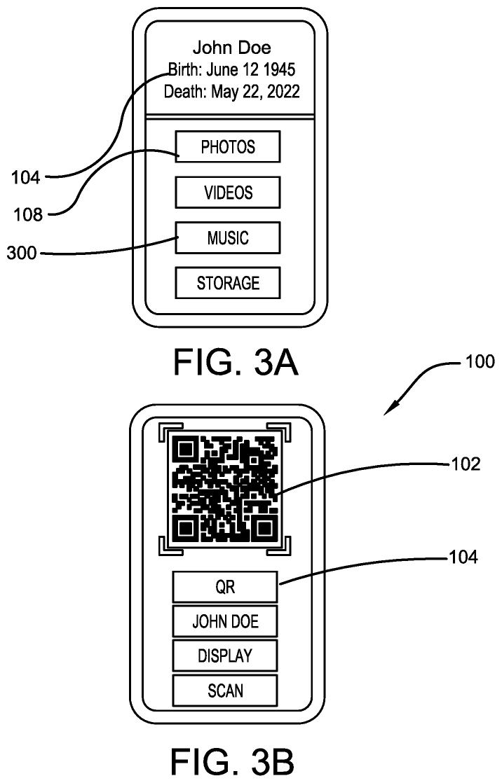

As shown in FIGS. 3A-B, the device 100 comprises different subscription levels 300 of the application 108 to allow for various media displaying functions and content storage. Users 110 can pay more for a higher subscription level 300, which provides for displaying audio as well as photos. For example, the basic subscription level only provides for displaying photos of the deceased. The next subscription level provides for displaying photos and articles. Another subscription level would provide for displaying photos, articles, videos, family trees, etc. Further, the device 100 can also include different account plans, such that single users can have less expensive plans than families of multiple users, etc. Additionally, there may be several categories to determine which type of information 112 is to be displayed on each profile, such as videos, photos, favorite music, etc. Users 110 would upload specific information in the correct category.

Those skilled in the art will appreciate that the invention may be practiced in network computing environments with many types of computer system configurations including, personal computers, desktop computers, laptop computers, message processors, hand-held devices, multi-processor systems, microprocessor-based or programmable consumer electronics, network PCs, minicomputers, mainframe computers, mobile telephones, smart devices, PDAs, tablets, pagers, routers, switches, etc.

The invention may also be practiced in distributed system environments where local and remote computer systems, which are linked (either by hardwired data links, wireless data links, or by a combination of hardwired and wireless data links) through a network both perform tasks. In a distributed system environment, program modules may be located in both local and remote memory storage devices.

Generally, the headstone/gravestone 106 contains a two-dimensional barcode (or QR code 102). Other types of scannable codes could also be used in the same manner as the QR code 102. The QR code 102 is uniquely associated with the deceased. In this manner, by scanning the QR code 102, an application 108 executed on a smartphone 104 can retrieve photos, videos, music, and other information 112 about the deceased.

Furthermore, a database 218 of QR codes 102 can be maintained (i.e., on a server system 302 with which a smartphone 104 can communicate). Each of the QR codes 102 in the database 218 can be associated with a unique individual. The database 218 can also store photos, videos, music, and other personal information 112 for each of the individuals. In such cases, when a user 110 scans a QR code 102 with a smartphone 104, an application 108 on the smartphone 104 can access the database 218 to identify the information 112 associated with the specific QR code 102. Additionally, each QR code 102 represents a unique identifier. When the QR code 102 is scanned, the unique identifier for the QR code 102 can be determined and used to query a data structure to obtain the personal information 112 associated with the QR code 102.

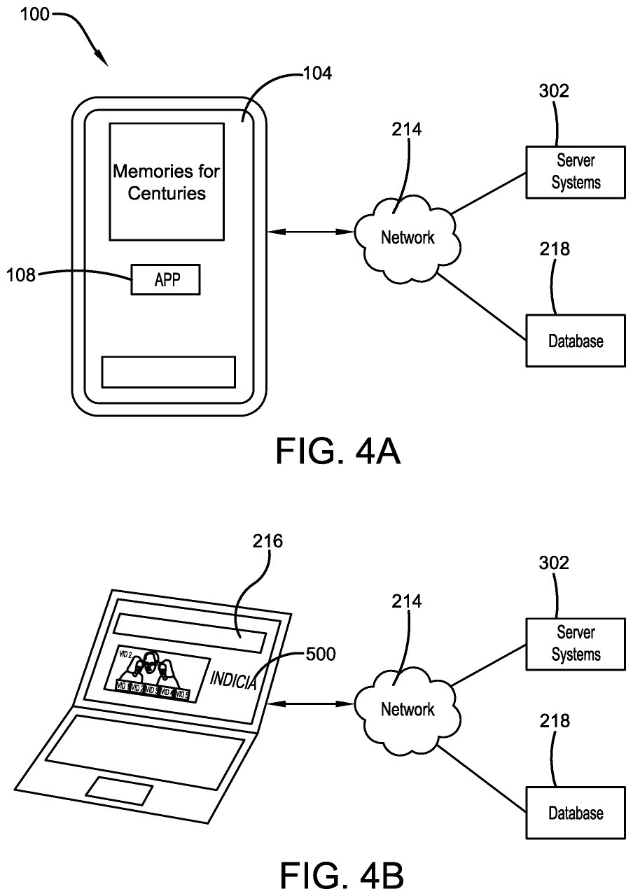

As shown in FIGS. 4A-B, the present invention can provide a website 216 or other application where an individual or other user 110 can input their personal information 112 or a deceased individual's personal information 112 to receive a QR code 102 associated with the personal information 112 that can be displayed on a headstone/gravestone 106.

Furthermore, an example computer environment includes a mobile computing device 104 which may typically be a smartphone 104 having a camera with which a QR code 102 can be scanned. The mobile computing device 104 is interconnected via a network 214 with multiple server systems 302. The server systems 302 can represent the systems where a user's or a deceased's personal information 112 is stored. The specific manner in which the personal information 112 is accessed is not essential to the invention. The network 214 typically will be the internet, although other networks can also be employed. For example, in a typical implementation, the mobile computing device 104 will communicate with one or more of the server systems 302 using a Wi-Fi or cellular (i.e., 4G) connection. Also, although this specification will primarily refer to using a smartphone 104, any mobile computing device 104 capable of performing the described functionality could also be used (i.e., a tablet).

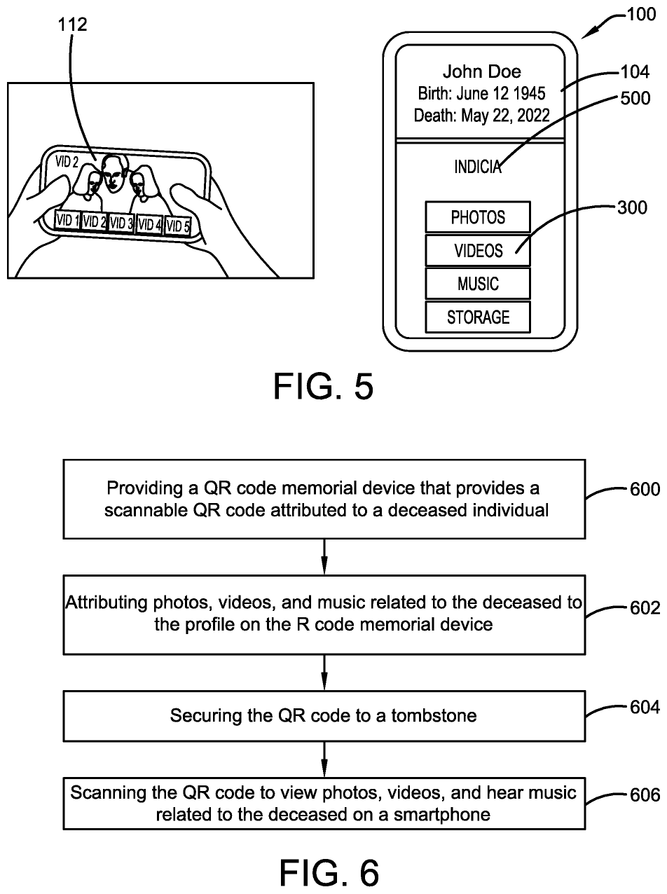

As shown in FIG. 5, the QR code memorial device 100 can be utilized with any suitable gravestone 106, headstone, tombstone, memorial, etc., as is known in the art, including headstones, tombstones, and memorials for pets.

In one embodiment, the QR code memorial device 100 comprises a plurality of indicia 500. The mobile application 108 of the device 100 may include advertising, a trademark, or other letters, designs, or characters, printed, painted, stamped, or integrated into the mobile application 108, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be gravestone, memory, or brand related.

FIG. 6 illustrates a flowchart of the method of memorializing a deceased individual via a scannable QR code which displays photos, videos, and music relating to the deceased individual. The method includes the steps of at 600, providing a QR code memorial device that provides a scannable QR code attributed to a deceased individual. The method also comprises at 602, attributing photos, videos, and music related to the deceased to the profile on the QR code memorial device. Further, the method comprises at 604, securing the QR code to a tombstone. Finally, the method comprises at 606, scanning the QR code to view photos, videos, and hear music related to the deceased on a smartphone.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “QR code memorial device”, “QR code device”, “memorial device”, and “device” are interchangeable and refer to the QR code memorial device 100 of the present invention.

Notwithstanding the foregoing, the QR code memorial device 100 of the present invention can be of any suitable size and configuration as is known in the art without affecting the overall concept of the invention, provided that it accomplishes the above-stated objectives. One of ordinary skill in the art will appreciate that the QR code memorial device 100 as shown in FIGS. 1-6 are for illustrative purposes only, and that many other sizes and shapes of the QR code memorial device 100 are well within the scope of the present disclosure. Although the dimensions of the QR code memorial device 100 are important design parameters for user convenience, the QR code memorial device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A QR code memorial device that provides a user with a scannable QR code capable of displaying a profile of the deceased, the QR code memorial device comprising:
a QR code;
a mobile application; and
a smartphone;
wherein the QR code is printed on a tombstone;
wherein a profile for a deceased individual is created on the mobile application, which is linked to the QR code; and
further wherein users scan the QR code to display the profile.

2. The QR code memorial device of claim 1, wherein the profile includes personal information relating to the deceased individual.

3. The QR code memorial device of claim 2, wherein the personal information comprises a photograph, a video, a favorite music, a family tree, a biography and an article.

4. The QR code memorial device of claim 3, wherein the QR code is located on a front or a side of a main body of the tombstone.

5. The QR code memorial device of claim 4, wherein the QR code is printed directly on a surface of the main body or engraved, or the QR code is printed on a surface of a thin plastic film which is secured to the tombstone.

6. The QR code memorial device of claim 5, wherein the QR code comprises a waterproofing coating that is a transparent resin which covers an entire QR code with a film and forms a tight seal.

7. The QR code memorial device of claim 6, wherein a smartphone scans the QR code which engages a website or a mobile application through a wireless communication network.

8. The QR code memorial device of claim 7, wherein the website and the mobile application have a database which stores the personal information of the deceased individual.

9. The QR code memorial device of claim 8, wherein the personal information of the deceased individual can be accessed by accessing the database.

10. The QR code memorial device of claim 9, wherein the database can be maintained on a server system with which the smartphone and the website can communicate and each of the QR codes attributed to the database are associated with a unique individual.

11. The QR code memorial device of claim 10 further comprising different subscription levels and different account plans.

12. A QR code memorial device that provides a user with a scannable QR code capable of displaying a profile of the deceased, the QR code memorial device comprising:
a QR code;
a mobile application or a website; and
a smartphone;
wherein the QR code is printed on a front or a side of a main body of a tombstone;
wherein a profile for a deceased individual is created on the mobile application or the website, which is linked to the QR code;
wherein a smartphone scans the QR code which engages the website or the mobile application through a wireless communication network;
wherein the website and the mobile application have a database which stores the profile of the deceased individual;
wherein the profile of the deceased individual can be accessed by accessing the database;
wherein the database can be maintained on a server system with which the smartphone and the website can communicate and each of the QR codes attributed to the database are associated with a unique individual; and
further wherein users scan the QR code to display the profile.

13. The QR code memorial device of claim 12 further comprising a plurality of indicia.

14. The QR code memorial device of claim 12, wherein the QR code memorial device can be utilized with headstones, tombstones, and memorials for pets.

15. The QR code memorial device of claim 12, wherein the QR code is printed directly on a surface of the main body or engraved, or the QR code is printed on a surface of a thin plastic film which is secured to the tombstone.

16. The QR code memorial device of claim 12, wherein the QR code comprises a waterproofing coating that is a transparent resin which covers an entire QR code with a film and forms a tight seal.

17. The QR code memorial device of claim 12 further comprising different subscription levels and different account plans.

18. The QR code memorial device of claim 12, wherein the profile includes personal information relating to the deceased individual.

19. The QR code memorial device of claim 18, wherein the personal information comprises photographs, videos, favorite music, family trees, biographies, or articles.

20. A method of memorializing a deceased individual via a scannable QR code which displays photos, videos, and music relating to a deceased individual, the method comprising the following steps:
providing a QR code memorial device that provides a scannable QR code attributed to a deceased individual;
attributing photos, videos, and music related to the deceased to the profile on the QR code memorial device;
securing the QR code to a tombstone; and
scanning the QR code to view photos, videos, and hear music related to the deceased on a smartphone.
